(19) United States
(12) Patent Application Publication
(10) Pub. No.: US 2009/0011200 A1
(43) Pub. Date: Jan. 8, 2009

(54) PRINTING METHOD, PRINTED MATTER, AND PRINTER

(75) Inventors: Seiichi Souma, Tomi-city (JP); Kazuaki Ikeda, Tomi-city (JP); Isao Tabayashi, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/147,913

(22) Filed: Jun. 27, 2008

(30) Foreign Application Priority Data
Jul. 2, 2007 (JP) 2007-173786

(51) Int. Cl. B32B 3/00; B05D 1/36; B05C 11/00

(52) U.S. Cl. 428/201; 427/258; 118/46

(57) ABSTRACT

A printing method for printing on a washable fabric medium by an inkjet system, where the method includes printing on the medium by the inkjet system using a water-based pigment ink containing an anionic resin. The method further includes applying a water-based coating agent containing water-soluble cationic resin particles to the medium before and/or after the printing on the medium.

### CROSS-REFERENCE TO RELATED APPLICATION

The present application claims priority to Japanese Patent Application No. 2007-173786, filed on Jul. 2, 2007, the entire contents of which are herein incorporated by reference.

### BACKGROUND OF THE INVENTION

1. Field of the Invention

The present invention relates to a printing method, a printed matter, and a printer, for example, for printing by an inkjet system.

2. Discussion of the Background

Conventionally, screen printing has been widely used for commercial printing. Generally used in screen printing is an ink containing a high-viscosity binder. In case of printing on a medium such as fabric, a printing providing fastness to washing can be conducted because of such ink.

The inventors of the present invention have studied printing on a medium such as fabric using an inkjet system. Typically, in order to improve the ink to be adapted to inkjet printing, a lowering of the viscosity of the ink is required. However, as the viscosity of the ink is lowered, other problems arise such as poor fastness to washing (i.e. the ink does not remain adhered to the fabric during washing of the fabric).

Since an inkjet printing system is a system in which ink is ejected out of micro holes, a workable ejected amount of ink leads to a poor (i.e., small) volume of the binder on a surface of the medium such as fabric. Therefore, when the printed matter is washed in practical use, the printed surface may be rubbed physically, and the printed matter may not have sufficient fastness to washing and sufficient fastness to rubbing.

JP-A-2-295787 describes printing on a medium such as a fabric using an inkjet system. However, in view of the problems regarding fastness to washing and the fastness to rubbing as mentioned above, it is difficult to achieve suitable printing by these methods. In general, it is considered that there is a trade-off relationship between improvement in fastness and operational reliability according to the increase in viscosity of ink in the inkjet system, and it is considered technically difficult to obtain a printed matter (printed subject) that can satisfy commercial qualities only by ink. Therefore, it is desired to develop a printing method, a printed matter, and a printer capable of solving the aforementioned problem.

### SUMMARY OF THE INVENTION

In one aspect of the present invention, a printing method for printing on a washable fabric medium by an inkjet system is providing that includes printing on the medium by the inkjet system using a water-based pigment ink containing an anionic resin, and applying a water-based coating agent containing water-soluble cationic resin particles to the medium before and/or after the printing on the medium.

In another aspect of the present invention, a printed matter printed by an inkjet system is provided that includes a washable fabric medium, a printing layer formed on the medium by the inkjet system by a water-based pigment ink containing an anionic resin, and a coating layer formed on and/or under the printing layer by a water-based coating agent containing water-soluble cationic resin particles.

In a further aspect of the present invention, a printer for printing on a washable fabric medium by an inkjet system is provided that includes a printing section configured to print on the medium by the inkjet system using a water-based pigment ink containing an anionic resin so as to form a printing layer, and a coating layer forming section configured to apply a water-based coating agent containing water-soluble cationic resin particles on and/or under the printing layer so as to form a coating layer.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is an illustration showing a structural example of a printed matter 10 according to an embodiment of the present invention; and

FIG. 2 is a flow chart showing an example of a printing method for the printed matter 10.

### DETAILED DESCRIPTION OF EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

An embodiment of the present invention provides a printing method for printing on a washable fabric medium by inkjet system that includes a printing step for printing on the medium by the inkjet system using a water-based pigment ink containing an anionic resin, and a coating agent applying step for applying a water-based coating agent containing water-soluble cationic resin particles to the medium at least before or after the printing step.

The fabric can be, for example, a cloth formed in a plate shape made of fibers. The fabric can be a woven fabric, a knitted fabric (stockinette), a lace, a felt, or a non-woven fabric. Fibers composing the fabric can be cotton fibers or synthetic fibers.

Accordingly, for example, it is possible to print on a fabric medium (conduct water pigment printing) by the inkjet system while improving the fastness to washing and the fastness to rubbing. Therefore, it is possible to obtain an inkjet printed matter having excellent fastness to washing and excellent fastness to rubbing, for example. In addition, the fastness to washing and the fastness to rubbing are improved without spoiling the beauty of the appearance of the print.

In the coating agent applying step, the water-based coating agent is applied by an applying system selected from, for example, an inkjet system, a splaying system, and a screen system. In the coating agent applying step, it is preferable to conduct heating and pressing after applying the water-based coating agent by the splaying system or the like. In this case, the fix level of the water-based coating agent relative to the water-based pigment ink is increased as compared to a case simply applying the water-based pigment ink and the water-based coating agent to be superposed on each other. In a case in which the coating agent applying step is conducted after the printing step, the printed ink is preferably subjected to baking for drying the ink between the printing step and the coating agent applying step, for example. Therefore, the water-based coating agent is more suitably applied.

The pH of the water-based coating agent applied in the coating agent applying step is in a range of, for example, from 3 to 7. The viscosity of the water-based coating agent is in a range of, for example, from 1 to 250 mPa·s (at a temperature of 25° C.). The resin solid content of the water-based coating agent after being applied is in a range of, for example, from 0.5 to 10 mg per a square centimeter at least in the printed portion on the medium.

Another embodiment of the present invention provides a water-based coating agent that contains cationic polyurethane resin particles as the water-soluble cationic resin particles. Therefore, the fastness to washing is suitably improved while ensuring the flexibility. In addition, the adhesion and durability of the water-based coating agent are suitably improved.

The water-based coating agent contains the cationic polyurethane resin particles in an amount of, for example, from 1 to 50% by mass, preferably from 2 to 25% by mass, in solid content equivalent. The tensile force of the coating layer formed by the water-based coating agent is in a range of from 5 to 50 MPa, preferably from 30 to 50 MPa.

The resin skeleton of the cationic polyurethane resin particles is any one selected from polyester, polyether, and polycarbonate. It is especially preferable that the water-based coating agent contains, as the water-soluble cationic polyurethane resin particles, particles of a cationic polyurethane resin of polyether type having polyether resin skeleton. In this case, the water-based coating agent contains the cationic polyurethane resin particles of polyether type in an amount of from 5 to 50% by mass in solid content equivalent.

A further embodiment of the present invention provides a water-based coating agent that contains the cationic polyurethane resin particles in an amount of from 2 to 25% by mass in solid content equivalent and further contains an antidrying agent in an amount of from 5 to 50% by mass. Accordingly, nozzle clogging in an inkjet head can be suitably prevented, thereby also achieving further suitable printing by the inkjet system.

An embodiment of the present invention includes a printed matter printed on a washable fabric medium by the inkjet system that includes the fabric medium, a printing layer which is formed by printing on the medium by the inkjet system using a water-based pigment ink containing an anionic resin, and a coating layer which is formed at least on and under the printing layer by applying a water-based coating agent containing water-soluble cationic resin particles. This arrangement provides the above advantageous effects.

An embodiment of the present invention includes a printer for printing on a washable fabric medium by inkjet system that includes a printing section for printing on the medium by the inkjet system using a water-based pigment ink containing an anionic resin so as to form a printing layer which is a layer formed by the water-based pigment ink, and a coating layer forming section for applying a water-based coating agent containing water-soluble cationic resin particles at least on or under the printing layer so as to form a coating layer which is a layer of the applied water-based coating agent. This arrangement obtains the above advantageous effects.

The printer can conduct printing by any one of the above printing method embodiments. The printing section can be an inkjet head. The coating layer forming section can apply the water-based coating agent by an applying method selected from a group consisting of an inkjet system, a splaying system, and a screen system.

According to embodiments of the present invention, it is possible to suitably print on a fabric medium by inkjet system while improving the fastness to washing and the fastness to rubbing.

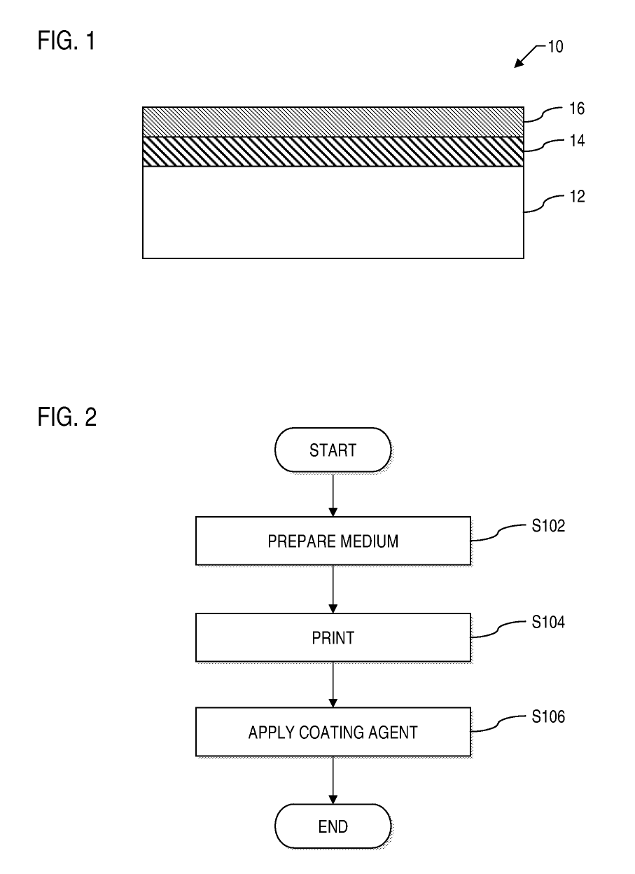

Hereinafter, an embodiment according to the present invention will be described with reference to the attached drawings. FIG. 1 is an illustration showing a structural example of a printed matter 10 according to an embodiment of the present invention. The printed matter 10 is a printed matter (printed subject) printed by inkjet system and includes a medium 12, a printing layer 14, and a coating layer 16.

The medium 12 is a medium which is washable fabric. This fabric can be a woven fabric, a knitted fabric (stockinette), a lace, a felt, or a non-woven fabric. Fibers composing the fabric can be cotton fibers or synthetic fibers.

The printing layer 14 is a layer of ink printed on the medium 12 by the inkjet system. In this embodiment, the printing layer 14 is formed by water-based pigment ink containing an anionic resin. The coating layer 16 is a layer formed by applying a water-based coating agent containing water-soluble cationic resin particles. In this embodiment, the coating layer 16 is formed on the printing layer 14. According to this structure, the surface of the printing layer 14 is covered, thereby suitably improving the fastness to washing and the fastness to rubbing.

The coating layer 16 can be formed under the printing layer 14. According to this structure, for example, the adhesion between the printing layer 14 and the medium 12 is increased, thereby suitably improving the fastness to washing and the fastness to rubbing. The coating layers 16 can be formed both on and under the printing layer 14.

FIG. 2 is a flow chart showing an example of a printing method for the printed matter 10. The printing method is a method for printing on a medium 12, which is washable fabric, by the inkjet system. In the printing method, first, the medium 12 is prepared by, for example, mounting the fabric medium 12 to a printer (preparing step S102).

Then, printing is carried out on the medium 12 by the inkjet system using the water-based pigment ink containing an anionic resin (printing step S104). After that, the water-based coating agent containing water-soluble cationic resin particles is applied to the medium 12 (coating agent applying step S106).

In this manner, it is possible to print on the fabric medium 12 (conduct water pigment printing) by the inkjet system while improving the fastness to washing and the fastness to rubbing. In addition, the fastness to washing and the fastness to rubbing are improved without spoiling the beauty of the appearance. Therefore, according to this embodiment, it is possible to obtain an inkjet printed matter having excellent fastness to washing and excellent fastness to rubbing, for example. It should be noted that, in a case in which the coating layer 16 is formed under the printing layer 14, the water-based coating agent is applied to the medium 12 before the printing step S104.

In the coating agent applying step S106, the coating agent is applied by an applying system selected from, for example, an inkjet system, a splaying system, and a screen system. In the coating agent applying step S106, it is preferable to conduct heating and pressing after applying the water-based coating agent by the splaying system or the like. In this case, the fix level of the water-based coating agent relative to the water-based pigment ink is increased.

The pH of the water-based coating agent applied in the coating agent applying step S106 is in a range of, for example, from 3 to 7. The viscosity of the water-based coating agent is in a range of, for example, from 1 to 250 mPa·s (at a temperature of 25° C.). The resin solid content of the water-based coating agent after being applied is in a range of, for example, from 0.5 to 10 mg per a square centimeter at least in the printed portion on the medium.

The water-based coating agent contains cationic polyurethane resin particles as the water-soluble cationic resin particles. In this case, the fastness to washing is suitably improved while ensuring the flexibility.

The water-based coating agent contains the cationic polyurethane resin particles in an amount of, for example, from 1 to 50% by mass, preferably from 2 to 25% by mass, in solid content equivalent. The tensile force of the coating layer formed by the water-based coating agent is in a range of from 5 to 50 MPa, preferably from 30 to 50 MPa.

The resin skeleton of the cationic polyurethane resin particles is any one selected from polyester, polyether, and polycarbonate. It is especially preferable that the water-based coating agent contains, as the water-soluble cationic polyurethane resin particles, particles of a cationic polyurethane resin of polyether type having polyether resin skeleton.

The water-based coating agent contains the cationic polyurethane resin particles in an amount of from 2 to 25% by mass in solid content equivalent and further contains an antidrying agent in an amount of from 5 to 50% by mass. Accordingly, nozzle clogging in an inkjet head can be suitably prevented, thereby also achieving further suitable printing by the inkjet system.

Hereinafter, the present invention will be described in further detail with reference to Examples and Comparative Examples. Since conditions as will be described below are for Examples, the present invention is not limited thereto. For example, the amount of the water-soluble cationic resin particles (cationic polyether-urethane resin particles) in the water-based coating agent and the applying amount can be changed depending on the surface roughness and thickness of the printed matter, and target texture.

### EXAMPLE 1

As the water-based coating agent of Example 1, an overcoating agent of a composition (Composition A) containing 50% Hydran CP-7030 available from Dainippon Ink and Chemicals Incorporated and 50% water was used. Hydran CP-7030 contains 22% resin content of polyester resin. In Example 1, after printing with color inks, the water-based coating agent of the aforementioned composition A was applied. The amount of resin solid content in the coating agent after being applied was 1.1 mg per a square centimeter.

### EXAMPLE 2

As the water-based coating agent of Example 2, an overcoating agent of a composition (Composition B) containing 50% Hydran CP-7020 available from Dainippon Ink and Chemicals Incorporated and 50% water was used. Hydran CP-7020 contains 40% resin content of polycarbonate resin. In Example 2, after printing with color inks, the water-based coating agent of the aforementioned composition B was applied. The amount of resin solid content in the coating agent after being applied was 1.9 mg per a square centimeter.

### COMPARATIVE EXAMPLE 1

In Comparative Example 1, only printing with color inks was conducted, that is, application of water-based coating agent was not conducted.

### Evaluation:

Tests for effect of improving the fastness to washing and the fastness to rubbing were carried out using the following procedures.

(1) In the printing step, a pattern of A4 size (624 square centimeter) is printed on a T-shirt as the fabric medium with an inkjet printing pigment as the water-based pigment ink containing an anionic resin.

(2) The printed pattern is subjected to baking at a temperature 160° C. for 60 seconds.

(3) In the coating agent applying step, 6 g of the overcoating agent is applied to the printed pattern by a hand spray. After the application, the coating agent applied portion is subjected to curing by hot press.

(4) Testing of the fastness to washing and the fastness to rubbing is carried out according to JIS dyeing inspection.

A printing pigment (color: cyan) manufactured by Mimaki Engineering Co., Ltd. was used as the color ink for printing. The printing was conducted under conditions of 720-720 dpi, one-way printing, 2-pass 1-coat, and 100% print density.

A white T-shirt was used as the T-shirt. The curing conditions for the overcoating agent were 160° C. and 180 sec. The tests for the fastness to washing and the fastness to rubbing were carried out with Tokyo office of Japan Dyers' Inspection Institute Foundation as an inspection agency.

Table 1 shows results of the tests of the fastness to washing and the fastness to rubbing. The fastness to washing was fastness to washing according to JIS L 0844 A-2. The fastness to rubbing was fastness to rubbing according to JIS L 0849II.

TABLE 1

| | Fastness | | |
|---|---|---|---|
| | to Washing | Fastness to Rubbing | Fastness to Rubbing |
| | (Discoloration) | (Dry Condition) | (Wet Condition) |
| Example 1 | 5 | 4 | 3 |
| Example 2 | 4-5 | 3 | 3 |
| Comparative | 4 | 2 | 2 |
| Example 1 | | | |

As shown in Table 1, it was found that the fastness to washing of each of Examples 1 and 2 was improved as compared to Comparative Example 1. It was also found that the fastness to rubbing of each of Examples 1 and 2 was improved both in cases of the dry condition and the wet condition as compared to Comparative Example 1.

Though the present invention has been described with regard to the embodiment, the technical scope of the present invention is not limited to the scope described in the aforementioned embodiment. It will be apparent to those skilled in the art that various modifications and improvements can be applied to the aforementioned embodiment. It is apparent from the claims of the present invention that embodiments with such modifications and improvements are within the technical scope of the present invention.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed is:

1. A printing method for printing on a washable fabric medium by an inkjet system, said method comprising:
printing on the medium by the inkjet system using a water-based pigment ink containing an anionic resin; and
applying a water-based coating agent containing water-soluble cationic resin particles to the medium before and/or after the printing on the medium.

2. The printing method according to claim 1, wherein the water-based coating agent contains cationic polyurethane resin particles as the water-soluble cationic resin particles.

3. The printing method according to claim 2, wherein the water-based coating agent contains the cationic polyurethane resin particles in an amount of from 2 to 25% by mass in solid content equivalent.

4. The printing method according to claim 2, wherein the water-based coating agent further contains an antidrying agent.

5. The printing method according to claim 2, wherein the water-based coating agent contains the cationic polyurethane resin particles in an amount of from 2 to 25% by mass in solid content equivalent and further contains an antidrying agent in an amount of from 5 to 50% by mass.

6. A printed matter printed by an inkjet system, said printed matter comprising:
a washable fabric medium;
a printing layer formed on said medium by the inkjet system by a water-based pigment ink containing an anionic resin; and
a coating layer formed on and/or under said printing layer by a water-based coating agent containing water-soluble cationic resin particles.

7. The printed matter according to claim 6, wherein said water-based coating agent contains cationic polyurethane resin particles as said water-soluble cationic resin particles.

8. The printed matter according to claim 7, wherein said water-based coating agent contains said cationic polyurethane resin particles in an amount of from 2 to 25% by mass in solid content equivalent.

9. The printed matter according to claim 7, wherein said water-based coating agent further contains an antidrying agent.

10. The printed matter according to claim 7, wherein said water-based coating agent contains said cationic polyurethane resin particles in an amount of from 2 to 25% by mass in solid content equivalent and further contains an antidrying agent in an amount of from 5 to 50% by mass.

11. A printer for printing on a washable fabric medium by an inkjet system, said printer comprising:
a printing section configured to print on the medium by the inkjet system using a water-based pigment ink containing an anionic resin so as to form a printing layer; and
a coating layer forming section configured to apply a water-based coating agent containing water-soluble cationic resin particles on and/or under the printing layer so as to form a coating layer.

12. The printer according to claim 11, wherein the water-based coating agent contains cationic polyurethane resin particles as the water-soluble cationic resin particles.

13. The printer according to claim 12, wherein the water-based coating agent contains the cationic polyurethane resin particles in an amount of from 2 to 25% by mass in solid content equivalent.

14. The printer according to claim 12, wherein the water-based coating agent further contains an antidrying agent.

15. The printer according to claim 12, wherein the water-based coating agent contains the cationic polyurethane resin particles in an amount of from 2 to 25% by mass in solid content equivalent and further contains an antidrying agent in an amount of from 5 to 50% by mass.
